(19) United States
(12) Patent Application Publication
(10) Pub. No.: US 2008/0105000 A1
(43) Pub. Date: May 8, 2008

(54) Fiberizing Device for Producing Fibers from Waste

(76) Inventor: Yao-Chung HU, Tainan Hsiang (TW)

Correspondence Address: Dr. BANGER SHIA;Int''l Patent Office of Bang Shia, 102 Lindencrest Ct, Sugar Land, TX, 77479-5201, US

(21) Appl. No.: 11/556,457

(22) Filed: Nov. 3, 2006

(51) Int. Cl. C03B 37/05

(52) U.S. Cl. 65/488; 65/520; 65/519

(57) ABSTRACT

A fiberizing device for producing fibers from waste includes a housing having an inlet for receiving molten fluid. Two rollers are rotatably mounted in the housing and include a space therebetween through which the molten fluid passes. Each roller is in contact with at least one centrifugal wheel. The molten fluid is driven through the space and rolled in the space by the rollers. The rolled molten fluid is drawn by the centrifugal wheel when the rolled molten fluid comes in contact with the centrifugal wheel, with the rolled molten fluid drawn by the centrifugal wheel being cooled to form solid fibers.

### BACKGROUND OF THE INVENTION

1. Field of the Invention

The present invention relates to a fiberizing device for producing fibers from waste.

2. Description of the Related Art

Industrial waste and other waste are generated during manufacture or after a period of time of use of various products. Typical treatment of these wastes includes burning the wastes in an incinerator or a melter into cinder and solid lumps. However, the solid lumps thus formed are generally buried, for they could not be treated through further heating. Transport of the solid lumps to the burying site and the burying process are inconvenient and incur cost. Although the molten lumps have been used as graded materials, the utility is low. There is a waste in resources, as the fire-resistant properties of the solid lumps are not well used. Further, the solid lumps have complicated compositions including considerable percentage of metal impurities and, thus, are not suitable for recycling. With reference to FIG. 11 showing relationship between temperature and viscosity, different molten fluids A and B resulting from different wastes have different solidification points and different extendible sections, leading to difficulty in production of fibers.

### SUMMARY OF THE INVENTION

An objective of the present invention is to provide a fiberizing device for producing fibers from waste with enhanced productive efficiency.

Another objective of the present invention is to provide a fiberizing device for producing fibers of smaller diameters from waste, allowing various applications of the fibers.

A fiberizing device for producing fibers from waste in accordance with the present invention comprises a housing including an inlet for receiving molten fluid and two rollers mounted in the housing. The rollers include a space therebetween through which the molten fluid passes. Each roller is in contact with at least one centrifugal wheel mounted in the housing. The fiberizing device further includes means for driving each roller and each centrifugal wheel The molten fluid is driven through the space and rolled in the space by the rollers. The rolled molten fluid is drawn by each centrifugal wheel when the rolled molten fluid comes in contact with each centrifugal wheel, with the rolled molten fluid drawn by each centrifugal wheel being cooled to form solid fibers.

The housing may further include a gas inlet for introducing inert gas into the housing.

The housing may further include an inlet tube for receiving molten fluid, cinders, or solid lumps.

Preferably, a vent and a temperature sensor are mounted in the inlet tube.

Preferably, a receiving seat is mounted between the inlet tube and the housing. A heating device is mounted to the receiving seat for heating the molten fluid, cinders, or solid lumps to molten fluid having a temperature allowing rolling.

The heating device may be a high-frequency wave heater or an electrode type heater.

Preferably, each roller includes a plurality of grooves in an outer circumference thereof, allowing the molten fluid to spread out in the grooves for increasing free surface area of the molten fluid.

Preferably, each centrifugal wheel includes a plurality of bristles on an outer circumference thereof and in contact with an outer circumference of an associated one of the rollers.

Preferably, the housing further includes a blower for assisting in collection of the solid fibers.

Preferably, the molten fluid after rolling is drawn by a centrifugal force by each centrifugal wheel and cooled with air cooling to form the solid fibers.

Each roller may cooperate with one or more centrifugal wheels.

Other objectives, advantages, and novel features of the invention will become more apparent from the following detailed description when taken in conjunction with the accompanying drawings.

### BRIEF DESCRIPTION OF THE DRAWINGS

FIG. 1 is a schematic sectional view illustrating a fiberizing device in accordance with the present invention.

FIG. 2 is a perspective view illustrating a rolling wheel and a centrifugal wheel of the fiberizing device in FIG. 1.

FIG. 3 is another sectional view of the fiberizing device in FIG. 1.

FIG. 4 is a view similar to FIG. 1, illustrating feeding of molten fluid to the rolling wheels.

FIG. 5 is a view similar to FIG. 4, illustrating rolling by the rolling wheels.

FIG. 6 is a view illustrating molten fluid on an outer circumference of a rolling wheel.

FIG. 7 is a view similar to FIG. 5, illustrating formation of fibers by the centrifugal wheels.

FIG. 8 is a view similar to FIG. 7, illustrating formation and collection of fibers.

FIG. 9 is a sectional view illustrating another example of the fiberizing device in accordance with the present invention.

FIG. 10 is a sectional view illustrating a further example of the fiberizing device in accordance with the present invention.

FIG. 11 is a diagram illustrating relationship between temperature and viscosity of different molten fluids.

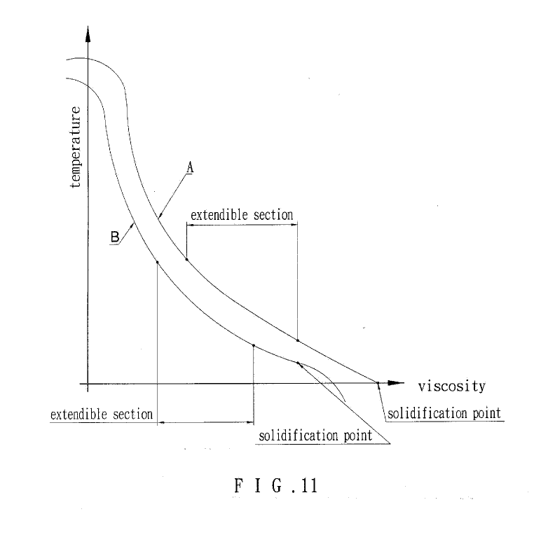

### DETAILED DESCRIPTION OF THE PREFERRED EMBODIMENTS

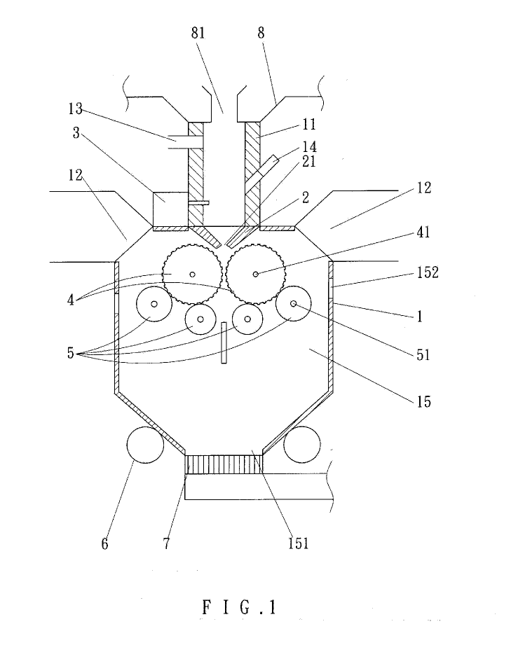

FIG. 1 shows an example of a fiberizing device for producing fibers from waste in accordance with the present invention. In this example, the fiberizing device comprises a housing 1, a receiving seat 2, a heating device 3, two rollers 4, four centrifugal wheels 5, a transmission device 6, and a blower 7.

The housing 1 includes an inlet tube 11 that is in communication with a discharge port 81 of a burner 8. The housing 1 further includes gas inlets 12 for guiding inert gas into the housing 1. A vent 13 and a temperature sensor 14 are provided in the inlet tube 11. The temperature sensor 14 may be an infrared temperature sensor. A blower (not shown) may be mounted in the vent 13. A compartment 15 is defined in the housing 1 for receiving the rollers 4 and the centrifugal wheels 5 and includes a fiber exit 151. The housing 1 further includes a window 152 through which a worker may see the interior of the housing 1. The fiber exit 151 may be connected to an external collecting device (not shown).

The receiving seat 2 is mounted below the inlet tube 11 and includes a molten fluid outlet 21 wide enough to allow outflow of the molten fluid.

The heating device 3 may be a high-frequency wave heater, an electrode-type heater, or other heater capable of heating cinders, molten fluid, or solid lumps fed to the receiving seat 2 into molten fluid having a temperature allowing rolling.

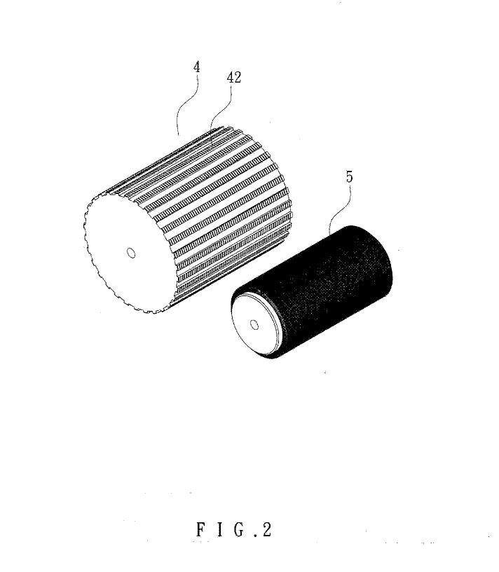

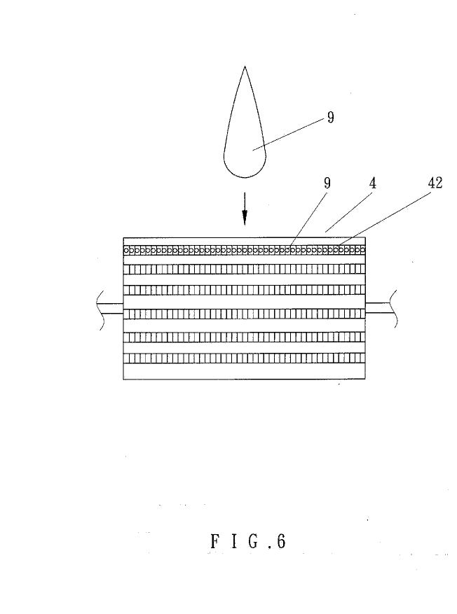

Each roller 4 includes a shaft 41 rotatably supported below the molten fluid outlet 21 of the receiving seat 2. The rollers 4 have a space therebetween and rotate in reverse directions for rolling purposes. Each roller 4 has an outer circumference that allows easy sticking of the molten fluid. Preferably, the outer circumference of each roller 4 is made of SUS310S stainless steel, ceramic material or other suitable material. Further, the outer circumference of each roller 4 includes a plurality of grooves 42 (see FIGS. 2 and 6) into which the molten fluid enters, thereby increasing the free surface area of the molten fluid.

Each centrifugal wheel 5 includes a shaft 51 rotatably supported by the housing 1 in a position near an associated roller 4. Bristles (not labeled) are provided on an outer circumference of each centrifugal wheel 5 and in contact with the outer circumference of the associated roller 4. Each roller 4 cooperates with two centrifugal wheels 5 that are in contact with the outer circumference of the associated roller 4 at different positions.

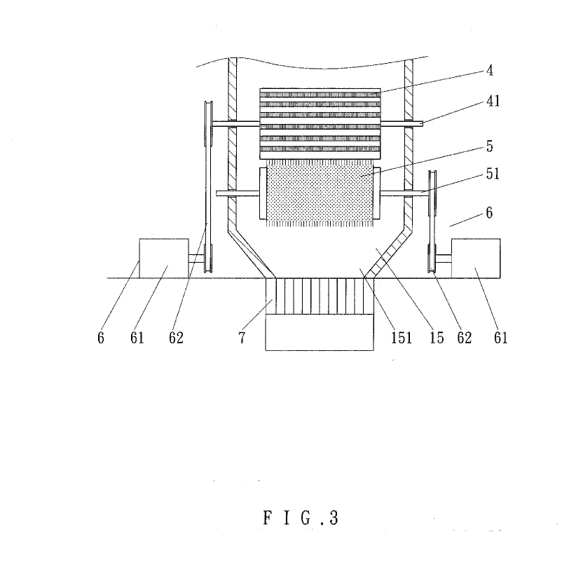

The transmission device 6 is mounted outside the housing 1 and includes a plurality of motors 61 and a plurality of transmission belts 62 (see FIG. 3). The shafts 41 and 51 of the rollers 4 and the centrifugal wheels 5 are driven via the transmission belts 62 when the motors 61 are activated. The blower 7 is mounted in the fiber exit 151 for moving the fibers out of the housing 15.

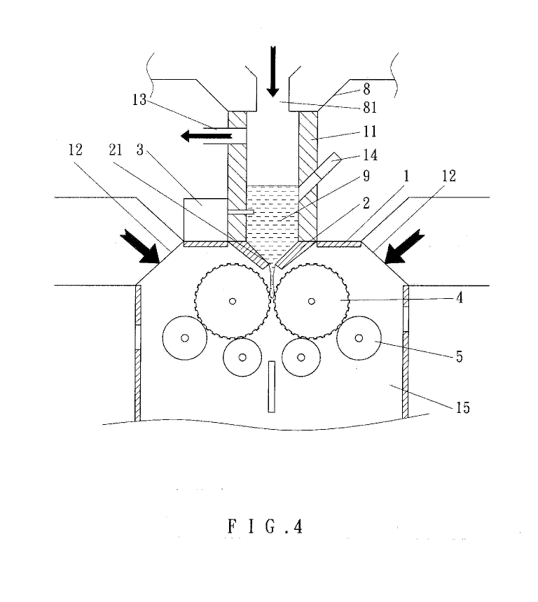

Referring to FIG. 4, molten fluid 9 from the burner 8 is guided to the inlet tube 11 and the receiving seat 2 above the housing 1 and rapidly heated by the heating device 3 to the temperature allowing rolling, with the temperature being detected by the infrared temperature sensor 14 and with the feeding speed of the molten fluid being controlled. The heating device 3 is not activated when the molten fluid 9 from the burner 8 reaches the temperature allowing rolling. In the example shown in FIG. 4, cinders or molten fluid is guided from the burner 8 to the inlet tube 11. In a case that solid lumps are fed to the inlet tube 11, the solid lumps can be heated by the heating device 3 to molten fluid 9 having a temperature suitable for rolling. Smoke in the inlet tube 11 can be exhausted via the vent 13.

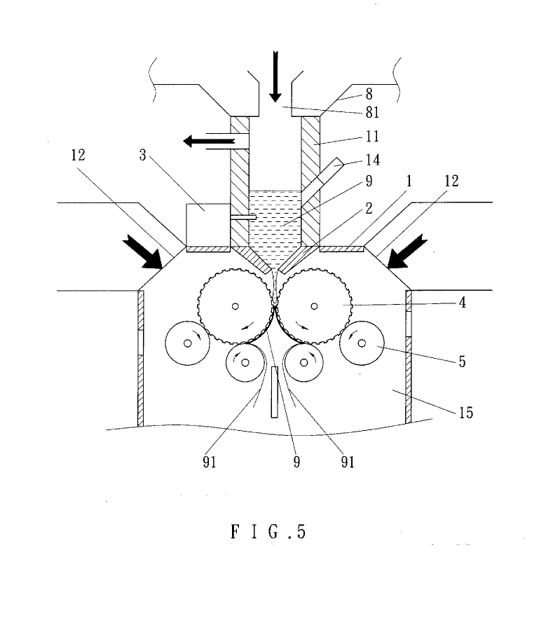

Referring to FIGS. 4 to 6, the molten fluid 9 flows from the molten fluid outlet 21 to the space between the rollers 4 and is rolled in the space by the rollers 4 to destroy the tension of the molten fluid 9. The grooves 42 of the rollers 4 allow spreading of the molten fluid 9, thereby increasing the free surface area of the molten fluid 9 (see FIG. 6). After rolling, the molten fluid 9 sticks to the outer circumferences of the rollers 4 (see the bold lines in FIG. 5). The molten fluid 9 is rolled while the rollers 4 rotate, with the rollers 4 imparting kinetic energy to the molten fluid 9. When the molten fluid 9 on each roller 4 comes in contact with the bristles of the nearer centrifugal wheel 5, the molten fluid 9 is drawn away from the roller 4 by the bristles of the nearer centrifugal wheel 5 in a centrifugal direction and instantaneously solidifies into an elongated solid fiber 91 via air cooling effect. Under the action of the kinetic energy imparted by the rollers 4 to the molten fluid 9 and the centrifugal force provided by the centrifugal wheels 5, the elongated solid fibers 91 disengage from the outer circumferences of the rollers 4 and the centrifugal wheels 5.

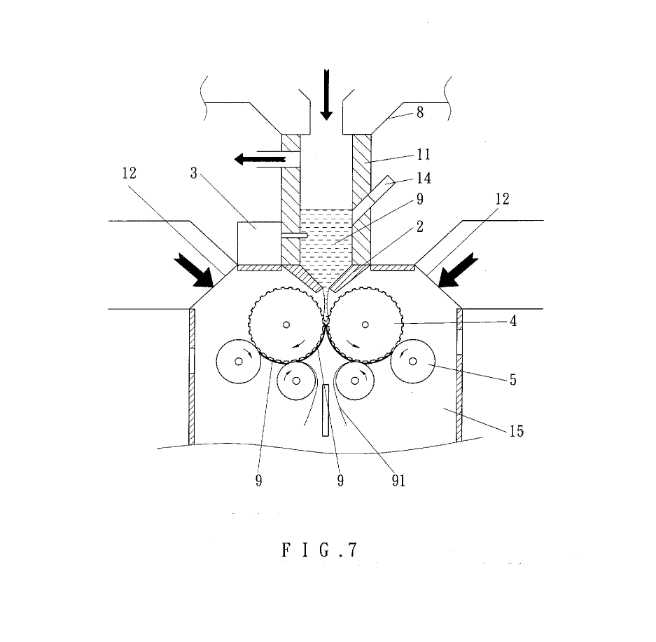

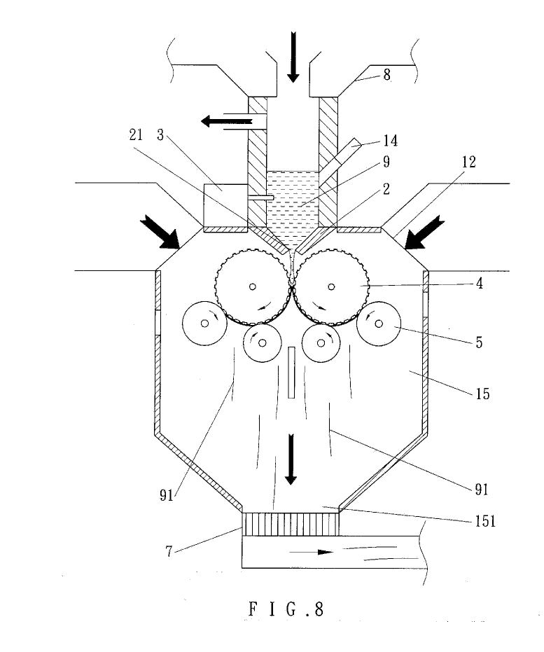

Referring to FIGS. 7 and 8, when the residual molten fluid 9 on each roller 4 comes into contact with the bristles of the other associated centrifugal wheel 5, the molten fluid 9 is drawn away from the roller 4 by the bristles of the other associated centrifugal wheel 5 in a centrifugal direction and instantaneously solidifies into an elongated solid fiber 91 via air cooling effect. Again, under the action of the kinetic energy imparted by the rollers 4 to the molten fluid 9 and the centrifugal force provided by the centrifugal wheels 5, the elongated solid fibers 91 disengage from the outer circumferences of the rollers 4 and the centrifugal wheels 5. The solid fibers 91 obtained by rolling and subsequent drawing have smaller diameters to enhance utility. Inert gas such nitrogen can be introduced via the gas inlets 12 to isolate from oxygen, avoiding oxidization of the rollers 4 and the centrifugal wheels 5 and thus prolonging the lives of the rollers 4 and the centrifugal wheels 5. The solid fibers 91 can be guided out of the housing 1 via the fiber exit 151 and then collected by a collecting device (not shown).

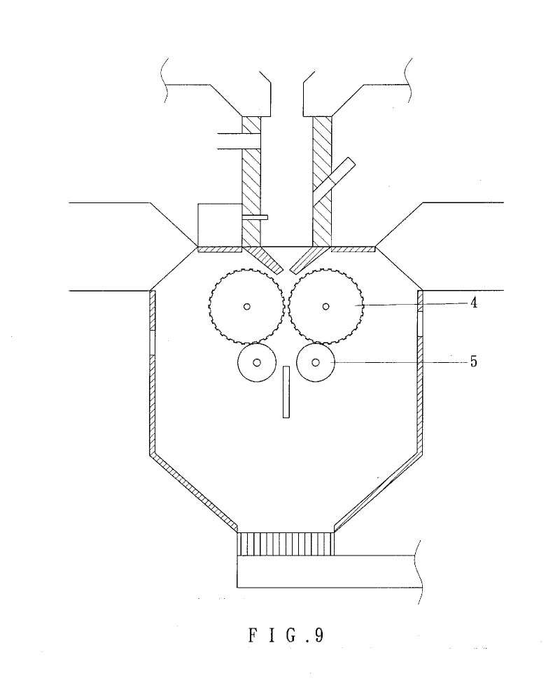

FIG. 9 is a sectional view illustrating another example of the fiberizing device for carrying out the method for producing fibers in accordance with the present invention, wherein each roller 4 cooperates with a single centrifugal wheel 5. The fiber-producing rate is lower than that in the first example.

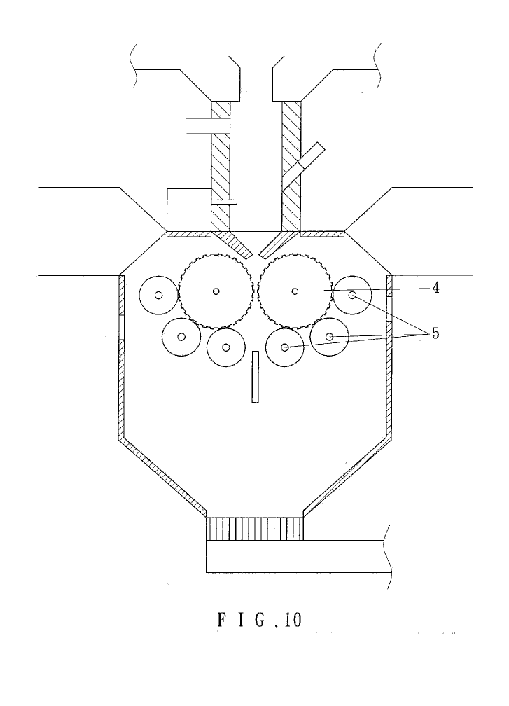

FIG. 10 is a sectional view illustrating a further example of the fiberizing device for carrying out the method for producing fibers in accordance with the present invention, wherein each roller 4 cooperates with three centrifugal wheels 5. The fiber-producing rate is higher than that in the first example.

The speed of the rollers 4 can be altered in response to molten fluid with different compositions to thereby change the time of rolling. Further, the speed of the rollers 4 and the centrifugal wheels 5 can be altered to change the diameter of the solid fibers 91. Further separation procedure can be carried out on the collected solid fibers 91 to obtain slim fiber bodies and coarse fiber bodies. The slim fiber bodies can be added into cement or artificial boards to enhance the strength as well as other properties.

The method of the present invention can be carried out with other devices such as tractor type or centrifugal drawing type devices. Further, more than two rollers can be used, and the outer circumference of each roller may include protrusions. Further, the heating device and the blower can be omitted, and the fibers may fall under the action of gravity.

Although specific embodiments have been illustrated and described, numerous modifications and variations are still possible without departing from the essence of the invention. The scope of the invention is limited by the accompanying claims.

1. A fiberizing device for producing fibers from waste, the fiberizing device comprising:
a housing including an inlet for receiving molten fluid;
two rollers rotatably mounted in the housing and including a space therebetween through which the molten fluid passes, each said roller being in contact with at least one centrifugal wheel mounted in the housing; and
means for driving each said roller and each said at least one centrifugal wheel;
wherein the molten fluid is driven through the space and rolled in the space by the rollers;
wherein the rolled molten fluid is drawn by each said at least one centrifugal wheel when the rolled molten fluid comes in contact with each said at least one centrifugal wheel, with the rolled molten fluid drawn by each said at least one centrifugal wheel being cooled to form solid fibers.

2. The fiberizing device as claimed in claim 1 wherein the housing further includes a gas inlet for introducing inert gas into the housing.

3. The fiberizing device as claimed in claim 2 wherein the housing further includes an inlet tube for receiving molten fluid, cinders, or solid lumps.

4. The fiberizing device as claimed in claim 3 further including a vent and a temperature sensor in the inlet tube.

5. The fiberizing device as claimed in claim 3 further including a receiving seat between the inlet tube and the housing, a heating device being mounted to the receiving seat for heating the molten fluid, cinders, or solid lumps to molten fluid having a temperature allowing rolling.

6. The fiberizing device as claimed in claim 5 wherein the heating device is a high-frequency wave heater or an electrode type heater.

7. The fiberizing device as claimed in claim 1 wherein each said roller includes a plurality of grooves in an outer circumference thereof, allowing the molten fluid to spread out in the grooves for increasing free surface area of the molten fluid.

8. The fiberizing device as claimed in claim 1 wherein each said at least one centrifugal wheel including a plurality of bristles on an outer circumference thereof and in contact with an outer circumference of an associated one of the rollers.

9. The fiberizing device as claimed in claim 1 wherein the housing further includes a blower for assisting in collection of the solid fibers.

10. The fiberizing device as claimed in claim 1 wherein the molten fluid after rolling is drawn by a centrifugal force by each said at least one centrifugal wheel and cooled with air cooling to form the solid fibers.

11. The fiberizing device as claimed in claim 1 wherein each said roller cooperates with a centrifugal wheel.

12. The fiberizing device as claimed in claim 1 wherein each said roller cooperates with at least two centrifugal wheels.
